(19) United States
(12) Patent Application Publication
(10) Pub. No.: US 2011/0294526 A1
(43) Pub. Date: Dec. 1, 2011

(54) Method And System Of Delivering A Mobile-Terminated SMS Message

(75) Inventors: John M. Gafrick, Naperville, IL (US); Frances M. Chin, Naperville, IL (US)

(73) Assignee: Alcatel-Lucent USA Inc., Murray Hill, NJ (US)

(21) Appl. No.: 12/789,197

(22) Filed: May 27, 2010

(51) Int. Cl. H04W 4/12

(52) U.S. Cl. 455/466

(57) ABSTRACT

A Mobile Switching Center (MSC) receives a short message intended for a mobile station. The MSC determines whether the mobile station is registered at the MSC. If not registered, the MSC sends a query message to associated Mobility Management Entities (MMEs). One of the MMEs sends a message to the MSC indicating that the MME is serving the mobile station.

### FIELD OF THE INVENTION

The present invention relates generally to communication systems, and more particularly to Short Message Service (SMS).

### BACKGROUND OF THE INVENTION

Short Message Service (SMS) has become a very popular feature in communication systems. Because SMS messages are not time-dependent, an acknowledgement message typically is not sent to the sender of an SMS message.

Currently, when a Mobile Switching Center (MSC) receives an SMS message intended for a mobile station that is not indicated to be located at the MSC, the MSC sends a failure notification to the SMS server. The MSC server does not attempt to deliver the SMS in such a scenario. Instead, the Home Location Register (HLR) waits for the mobile station to register with the HLR so that the SMS delivery may be reattempted. In the meantime, the sender is still waiting for the SMS delivery to complete.

Therefore, a need exists for a method and system for reliably sending SMS messages to a mobile station when an MSC does not know where the mobile station is located.

### BRIEF SUMMARY OF THE INVENTION

An exemplary embodiment of the present invention provides a method for delivering an SMS message. The MSC sends an alert message or page message to all subtending MMEs.

An IWMSC sends an SMS message to the MSC. The SMS message is a request to send an SMS message to a mobile station. In accordance with an exemplary embodiment, the SGs association on the MSC between an MME and the MSC is not currently set.

If the mobile station is not registered with the MSC, the MSC queries subtending MMEs, preferably by sending an alert message to all subtending MMEs. The alert messages help the MSC to determine whether the intended mobile station has registered with any of the MMEs.

The MME to which the mobile station is registered an acknowledgement message to the MSC to indicate that the mobile station is registered with the associated MME.

The MSC preferably stores the SMS message and forwards to the mobile station via the acking MME after receiving the alert acknowledgement message from the MME.

In accordance with an exemplary embodiment, the mobile station sends a TAU (Tracking Area Update) message with combined TA/LA (Tracking Area/Location Area) updating to an eNodeB, which passes the TAU message to the responding MME.

In response to the TAU message, the MME sends a Location Update message to the MSC. In response to the Location Update message, the MSC re-registers mobile the station so that the SGs association between the MME and the MSC can be re-established.

The IWMSC sends an SMS message intended for the mobile station to the MSC. The MSC checks the SGs association for the mobile station. Since the MSC re-registered the mobile station and re-established an SGs association, the MSC acknowledges the receipt of the SMS message and processes the delivery of the SMS message to the mobile station.

### BRIEF DESCRIPTION OF THE SEVERAL VIEWS OF THE DRAWINGS

FIG. 1 depicts a portion of a communication system in accordance with an exemplary embodiment of the present invention.

FIG. 2 depicts a flow diagram of a method for delivering an SMS message in accordance with an exemplary embodiment of the present invention.

### DETAILED DESCRIPTION OF THE INVENTION

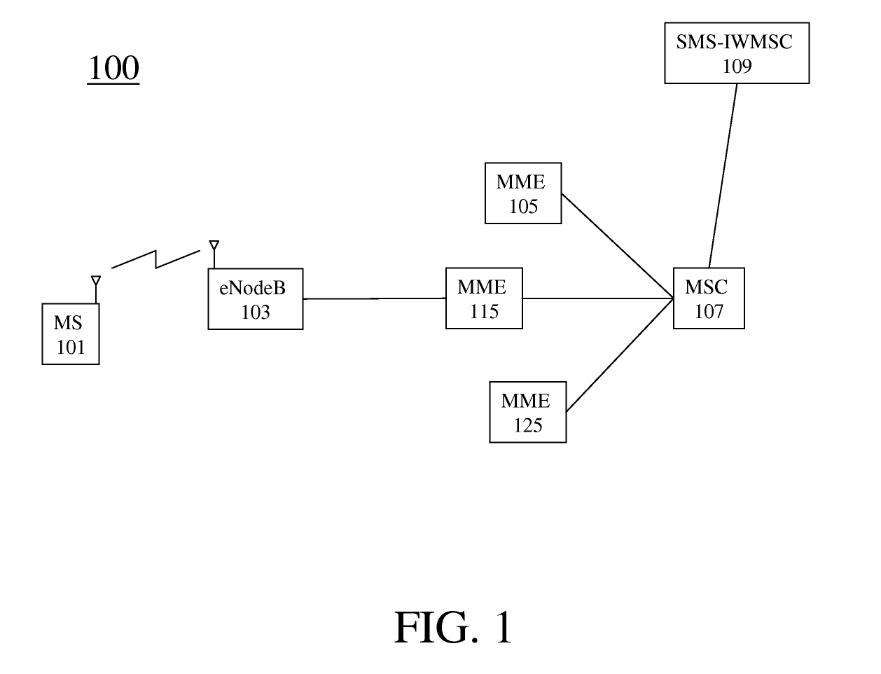

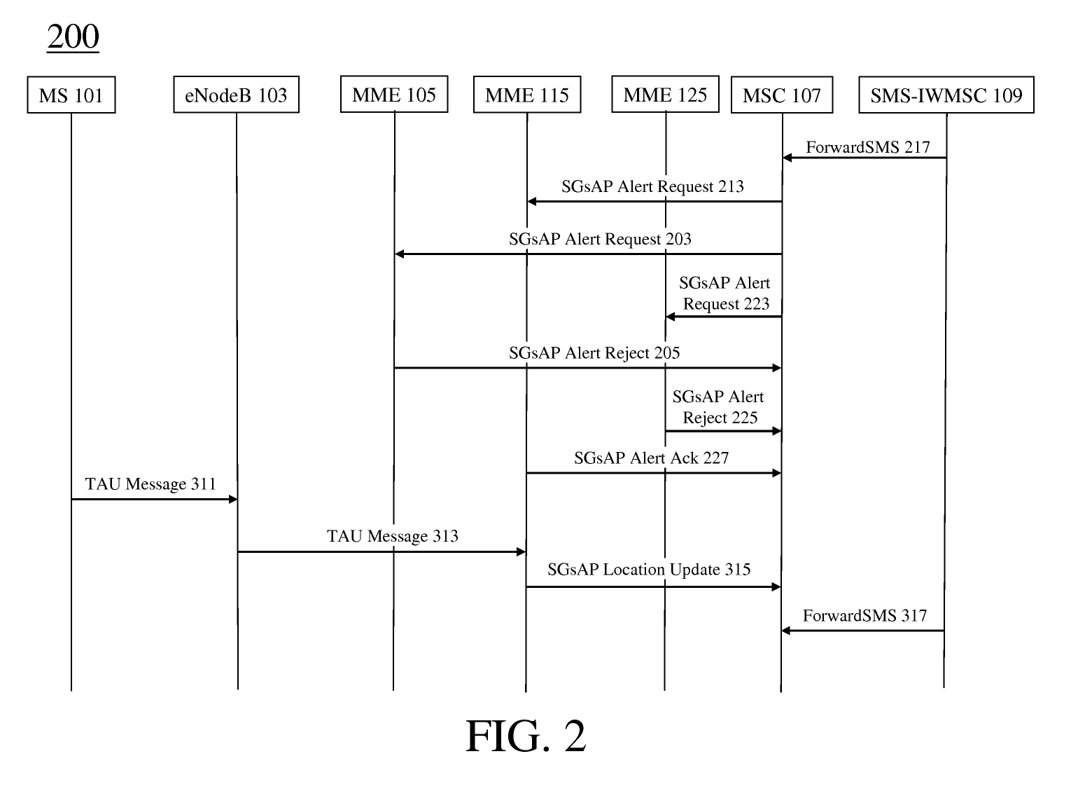

An exemplary embodiment of the present invention can be better understood with reference to FIGS. 1 and 2. FIG. 1 depicts a portion 100 of a communication system in accordance with an exemplary embodiment of the present invention. Portion 100 includes mobile station 101, eNodeB 103, MME 105, MME 115, MME 125, MSC 107, and SMS-IWMSC (SMS Interworking MSC) 109.

Mobile station 101 is a device supporting voice and data communication using a wireless air interface. In an exemplary embodiment, mobile station 101 is a Circuit Switch Fall Back (CSFB) mobile station camping on LTE technology.

eNodeB 103 is an LTE base station that communicates, over the air, with mobile station 101.

MME 105, MME 115, and MME 125 are Mobility Management Entities that each manage session states, authentication, paging, mobility with SGSN nodes, roaming, and other bearer management functions.

MSC 107 is a Mobile Switching Center. In an exemplary embodiment, MSC 107 comprises a 3G MSC. MSC 107 is the network element that provides voice services and enables mobile terminals to communicate to the Public Switched Telephone Network (PSTN).

SMS-IWMSC 109 is an MSC that is capable of receiving SMS messages from a mobile network and submitting the SMS messages to an appropriate Short Message Service Center (SMSC).

FIG. 2 depicts a flow diagram 200 of a method for delivering an SMS message in accordance with an exemplary embodiment of the present invention. In this exemplary embodiment, the MSC sends an alert message to all subtending MMEs. In an alternate exemplary embodiment, the MSC can send a page message and deliver the SMS to the MME that responds to the page message.

SMS-IWMSC 109 sends ForwardSMS message 217 to MSC 107. ForwardSMS message 217 is a request to send an SMS message to mobile station 101. In the exemplary embodiment depicted in FIG. 2, mobile station 101 is not registered with MSC 107. In an exemplary embodiment, the SGs association on MSC 107 between MME 115 and MSC 107 is not currently set. In a first exemplary embodiment, this can occur when a VLR record associated with mobile station 101 is deleted, for example due to VLR overload control or other administrative reasons. In a second exemplary embodiment, this can occur when the SGs association is equal to SGs-NULL.

In accordance with the exemplary embodiment, MSC 107 queries subtending MMEs, in this exemplary embodiment MME 105, MME 115, and MME 125, by sending SGsAP Alert Request message 213 to MME 115, SGsAP Alert Request message 203 to MME 105, and SGsAP Alert Request message 223 to MME 125. The SGsAP Alert Request messages will help MSC 107 determine whether mobile station 101 has registered with any of the MMEs. In an alternate exemplary embodiment, MSC 107 sends a page message, preferably over an SGs interface, to corresponding MMEs and delivers ForwardSMS message 217 to the MME that responds to the page message.

In this exemplary embodiment, mobile station 101 is registered with MME 115. Therefore MME 105 sends SGs Alert Reject message 205 to MSC 107 and MME 125 sends SGs Alert Reject message 225 to MSC 107.

MME 115 sends SGsAP Alert Ack message 227 to MSC 107. SGsAP Alert Ack message 227 indicates to MSC 107 that mobile station 101 is registered with MME 115.

In an exemplary embodiment, MSC 107 stores the SMS message and forwards to mobile station 101 via MME 115 after receiving SGsAP Alert Ack message 227 from MME 115.

In accordance with an exemplary embodiment, mobile station 101 sends a TAU (Tracking Area Update) message 311, preferably with combined TA/LA (Tracking Area/Location Area) updating to eNodeB 103. In an alternate exemplary embodiment, message 311 can be any message that indicates user activity by mobile station 101.

eNodeB 103 passes TAU message 311 to MME 115 via TAU message 313.

In response to TAU message 313, MME 115 sends an SGsAP Location Update message 315 to MSC 107. In response to SGsAP Location Update message 315, MSC 107 re-registers mobile station 101 so that the SGs association between MME 115 and MSC 107 can be re-established.

SMS-IWMSC 109 sends ForwardSMS message 317 to MSC 107. ForwardSMS message 317 is intended for mobile station 101. MSC 107 checks the SGs association for mobile station 101. Since MSC 107 re-registered mobile station 101 and re-established an SGs association, MSC 107 acknowledges the receipt of ForwardSMS message 317 and processes the delivery of the SMS message to mobile station 101.

While this invention has been described in terms of certain examples thereof, it is not intended that it be limited to the above description, but rather only to the extent set forth in the claims that follow.

We claim:

1. A method for recovering a location of a mobile station, the method comprising:
receiving a short message intended for a mobile station at a mobile switching center (MSC);
determining that the mobile station is not registered at the MSC;
sending a query message to a plurality of Mobility Management Entities (MMEs); and
receiving from one of the plurality of MMEs an indication that the one of the plurality of MMEs is serving the mobile station.

2. A method for recovering a location of a mobile station in accordance with claim 1, wherein the step of determining that the mobile station is not registered at the MSC comprises determining that the MSC has undergone maintenance.

3. A method for recovering a location of a mobile station in accordance with claim 1, wherein the step of determining that the mobile station is not registered at the MSC comprises determining that the MSC has experienced an overload condition.

4. A method for recovering a location of a mobile station in accordance with claim 1, the method further comprising the step of receiving at the MSC a second short message intended for the mobile station.

5. A method for recovering a location of a mobile station in accordance with claim 4, the method further comprising the step of delivering the second short message to the mobile station.

6. A method for recovering a location of a mobile station in accordance with claim 5, the method further comprising the step of delivering the second short message to the mobile station via the one of the plurality of MMEs.

7. A method for recovering a location of a mobile station in accordance with claim 1, the method further comprising the step of delivering the short message subsequent to receiving from one of the plurality of MMEs an indication that the one of the plurality of MMEs is serving the mobile station.

8. A method for recovering a location of a mobile station in accordance with claim 1, wherein the step of sending a query message to a plurality of MMEs comprises paging the plurality of MMEs.

9. A method for recovering a location of a mobile station in accordance with claim 1, wherein the step of sending a query message to a plurality of MMEs comprises sending an alert message to the plurality of MMEs.
